(19) United States
(12) Patent Application Publication
(10) Pub. No.: US 2025/0369618 A1
(43) Pub. Date: Dec. 4, 2025

(54) HEATING DEVICE AND COOKING APPLIANCE HAVING THE SAME

(71) Applicant: SAMSUNG ELECTRONICS CO., LTD., Suwon-si (KR)

(72) Inventors: Minkyung Lee, Suwon-si (KR); Moojin Kwak, Suwon-si (KR); Kyoungmok Kim, Suwon-si (KR); Juhyen Lee, Suwon-si (KR); Junhan Bae, Suwon-si (KR); Yongjoon Jang, Suwon-si (KR); Sungmin Cho, Suwon-si (KR); Donggi Han, Suwon-si (KR)

(73) Assignee: SAMSUNG ELECTRONICS CO., LTD., Suwon-si (KR)

(21) Appl. No.: 19/183,452

(22) Filed: Apr. 18, 2025

Related U.S. Application Data
(63) Continuation of application No. PCT/KR2025/004468, filed on Apr. 3, 2025.

(30) Foreign Application Priority Data
May 30, 2024 (KR) 10-2024-0070579
Nov. 11, 2024 (KR) 10-2024-0159672

(51) Int. Cl. F24C 7/06; H05B 3/03; H05B 3/14

(52) U.S. Cl. CPC F24C 7/06; H05B 3/03; H05B 3/145; H05B 2203/013

(57) ABSTRACT

A heating device includes: a power supply; a graphene heating layer configured to generate heat based on a current from the power supply and to allow light to pass therethrough; an electrode connected to the power supply, spaced apart from the graphene heating layer, and configured to receive the current from the power supply; and a conductive layer on a base and electrically connecting the graphene heating layer and the electrode.

### CROSS-REFERENCE TO RELATED APPLICATION(S)

This application is a continuation of International Application No. PCT/KR2025/004468, filed on Apr. 3, 2025, in the Korean Intellectual Property Receiving Office, which is based on and claims priority to Korean Patent Application No. 10-2024-0070579, filed on May 30, 2024 and Korean Patent Application No. 10-2024-0159672, filed on Nov. 11, 2024, in the Korean Intellectual Property Office, the disclosures of which are incorporated by reference herein in their entireties.

### BACKGROUND

### 1. Field

The present disclosure relates to a heating device that generates heat by using graphene, and a cooking appliance including the heating device.

### 2. Description of Related Art

Graphene is a two-dimensional material made of a single atomic layer and has a structure with carbon (C) atoms arranged in a two-dimensional lattice form. A surface heating element made of graphene may generate heat by connecting to electrodes and receiving power.

Graphene has high electrical conductivity, thermal conductivity, and light transmittance due to the arrangement of carbon atoms. Also, graphene has a property of bending due to external impact or pressure and has a strength stronger than steel due to its unique mesh structure (two-dimensional planar structure).

Due to the properties, heating devices with graphene are utilized in various technological and industrial fields in modern society.

### SUMMARY

Provided are a heating device with a structure of maintaining light transmittance, and a cooking appliance including the heating device.

Further, provided are a heating device with a structure capable of preventing deterioration in durability, and a cooking appliance including the heating device.

Further still, provided are a heating device including a structure capable of preventing a short circuit in an electrode or graphene even at a high temperature, and a cooking appliance including the heating device.

Further still, provided are a heating device including a structure capable of preventing structural instability due to thermal expansion mismatch between graphene and an electrode and a current crowding phenomenon due to a resistance difference, and a cooking appliance including the heating device.

Additional aspects will be set forth in part in the description which follows and, in part, will be apparent from the description, or may be learned by practice of the presented embodiments.

According to an aspect of the disclosure, a heating device may include: a power supply; a graphene heating layer configured to generate heat based on a current from the power supply and to allow light to pass therethrough; an electrode connected to the power supply, spaced apart from the graphene heating layer, and configured to receive the current from the power supply; and a conductive layer on a base and electrically connecting the graphene heating layer and the electrode.

The electrode may include a first electrode and a second electrode that are spaced apart on the conductive layer. The graphene heating layer may be between the first electrode and the second electrode, and spaced apart from the first electrode and the second electrode.

The first electrode, the second electrode, and the graphene heating layer may be in contact with the conductive layer. The conductive layer may be configured to allow light to pass between the base and the graphene heating layer.

A resistance of the conductive layer may be greater than a resistance of the electrode and less than a resistance of the graphene heating layer.

The first electrode, the second electrode, and the graphene heating layer may be on a first surface of the conductive layer. An area of the first surface of the conductive layer may be greater than a sum of an area of a contact surface of the first electrode with the first surface, an area of a contact surface of the second electrode with the first surface, and an area of a contact surface of the graphene heating layer with the first surface.

A contact surface of the conductive layer with the graphene heating layer may extend from a first side of the graphene heating layer that is adjacent to the first electrode to a second side of the graphene heating layer that is adjacent to the second electrode.

The conductive layer may include a first conductive film in contact with the base.

The conductive layer may further include a second conductive film between the first conductive film and the graphene heating layer. A first surface of the second conductive film may be in contact with the first conductive film, and a second surface of the second conductive film may be in contact with the graphene heating layer, the second surface being opposite to the first surface.

The second conductive film may include titanium or nickel.

A thickness of the second conductive film may be 5 nm or less.

A first surface of the graphene heating layer may be in contact with the conductive layer. The heating device may further include: an encapsulation layer covering a second surface of the graphene heating layer that is opposite to the first surface. The encapsulation layer may include an oxide metal material.

The conductive layer may include a first conductive layer on which the first electrode is provided, and a second conductive layer on which the second electrode is provided, the second conductive layer being spaced apart from the first conductive layer.

The graphene heating layer may include: a first area in contact with the first conductive layer and spaced apart from the first electrode, a second area in contact with the second conductive layer and spaced apart from the second electrode, and a third area between the first area and the second area and in contact with the base.

The first conductive layer may include a first conductive film in contact with the base, and a second conductive film between the first conductive film and the graphene heating layer. The second conductive layer may include a third conductive film in contact with the base, and a fourth conductive film between the third conductive film and the graphene heating layer.

The graphene heating layer may be on the conductive layer. The heating device may be configured to be light-transmissive.

The graphene heating layer may be indirectly connected to the electrode through the conductive layer.

According to an aspect of the disclosure, a heating device may include: a power supply; an electrode connected to the power supply, configured to receive current from the power supply, and including a first electrode and a second electrode spaced apart from the first electrode; a conductive layer electrically connected to the first electrode and the second electrode, and including a first side in contact with a base; and a graphene heating layer in contact with the conductive layer, between the first electrode and the second electrode, and configured to generate heat based on the current from the power supply and to allow light to pass therethrough. The first electrode, the second electrode, and the graphene heating layer may be on a second side of the conductive layer that is opposite to the first side.

The conductive layer may be configured to allow light to pass between the base and the graphene heating layer.

The conductive layer may include a first conductive film including the first side in contact with the base, and a second conductive film in contact with the first conductive film and including the second side that is opposite to the first side.

A resistance of the conductive layer may be greater than a resistance of the electrode and less than a resistance of the graphene heating layer.

According to an aspect of the disclosure, a cooking appliance may include a main body having a cooking room, a door rotatably coupled to the main body and configured to open or close the cooking room, and a heating device installed on the door and configured to heat the cooking room. The heating device may include a power supply, a pair of electrodes connected to the power supply to receive a voltage from the power supply and spaced from each other, a graphene heating layer configured to generate heat by receiving power and allow light to pass through, the graphene heating layer being spaced from the pair of electrodes, and a conductive layer configured to allow current to flow through and allow the pair of electrodes and the graphene heating layer to carry current to each other, wherein the pair of electrodes and the graphene heating layer are seated on one surface of the conductive layer, and another surface of the conductive layer is in contact with a base on which the heating device is mounted, the another surface of the conductive layer being opposite to the one surface of the conductive layer.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 conceptually shows a heating device according to a comparative embodiment;

FIG. 2 conceptually shows a heating device according to an embodiment of the disclosure;

FIG. 3 is a front view of FIG. 2 according to an embodiment of the disclosure;

FIG. 4 conceptually shows a heating device according to an embodiment of the disclosure;

FIG. 5 conceptually shows a heating device according to an embodiment of the disclosure;

FIG. 6 conceptually shows a heating device according to an embodiment of the disclosure;

FIG. 7 is a front view of FIG. 6 according to an embodiment of the disclosure;

FIG. 8 conceptually shows a heating device according to an embodiment of the disclosure; and

FIG. 9 conceptually shows a cooking appliance in which a heating device according to various embodiments of the disclosure is installed.

### DETAILED DESCRIPTION

Hereinafter, example embodiments of the disclosure will be described in detail with reference to the accompanying drawings. The embodiments described herein are example embodiments, and thus, the disclosure is not limited thereto and may be realized in various other forms.

Like reference numerals or symbols denoted in the drawings of the present specification represent members or components that perform the substantially same functions.

The terms used in the present specification are merely used to describe the embodiments and are not intended to limit and/or restrict the disclosure. An expression used in the singular encompasses the expression of the plural, unless it has a clearly different meaning in the context. In the present specification, it is to be understood that the terms such as “comprising”, “including” or “having”, and the like, are intended to indicate the existence of the features, numbers, steps, operations, components, parts, or combinations thereof disclosed in the specification, and are not intended to preclude the possibility that one or more other features, numbers, steps, operations, components, parts, or combinations thereof may exist or may be added.

Although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

Meanwhile, the shapes and positions of the components are not limited by the terms “front”, “rear”, “left”, “right”, “upper” and “lower”, etc. used in the following description.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

With regard to rotation directions, a clockwise direction may be expressed by a first direction, and a counterclockwise direction that is an opposite direction of the first direction may be expressed by a second direction. These expressions are used to describe details for embodying the disclosure, but rotation directions of the components of the disclosure are not limited by these terms.

Hereinafter, a heating device according to various embodiments and a cooking appliance including the heating device will be described in detail with reference to the accompanying drawings.

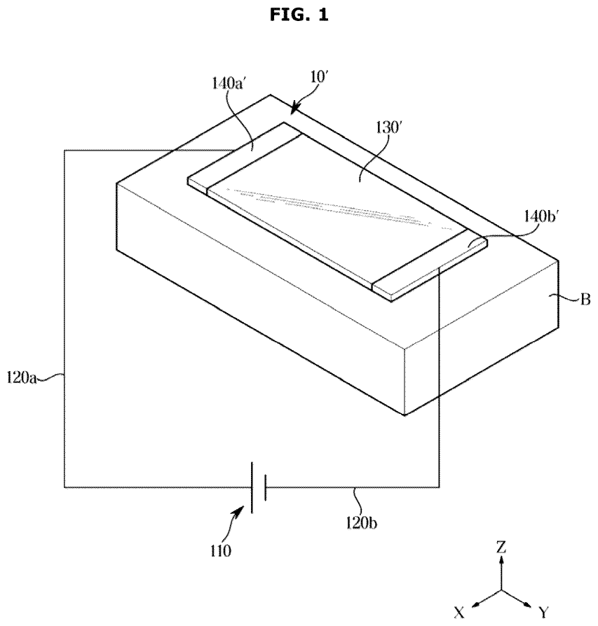

FIG. 1 conceptually shows a heating device according to a comparative embodiment.

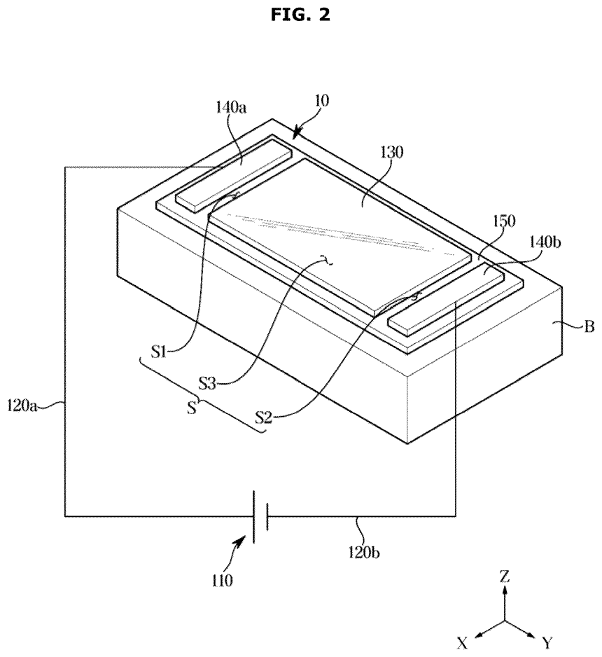

Hereinafter, a heating device 10′ according to an embodiment that is compared to a heating device 10 according to embodiments shown in FIGS. 2 to 9 will be described with reference to FIG. 1.

Referring to FIG. 1, the heating device 10′ according to the comparative embodiment may generate heat by receiving power.

The heating device 10′ may generate heat by receiving power from a power supply provided inside or outside the heating device 10′. The heating device 10′ may be mounted on a base B. The base B may be a heating target that is heated by the heating device 10′. The base B may include various kinds of components or devices capable of being heated by the heating device 10′ mounted thereon.

The heating device 10′ according to the comparative embodiment may include a power supply 110 that supplies power, an electrode 140′, which includes electrodes 140a′ and 140b′, that receives power from the power supply 110, a connector 120a and 120b that electrically connects the power supply 110 to the electrode 140′, and a graphene heating layer 130′ that receives power and generates heat. For example, the graphene heating layer 130′ may be in contact with the base B.

According to the comparative embodiment, the electrode 140′ may be in direct contact with the graphene heating layer 130′ to supply power to the graphene heating layer 130′.

While current moves from the electrode 140′ to the graphene heating layer 130′ by the electrode 140′ being in direct contact with the graphene heating layer 130′, as in the heating device 10′ according to the comparative embodiment, a current crowding phenomenon may be caused. The current crowding phenomenon refers to a phenomenon in which, according to objects with different resistances being connected to each other, current is concentrated toward the object with relatively lower resistance because current tends to flow to a path with lower resistance.

For example, in the case in which two objects in contact with each other have significantly different resistances, current is more concentrated toward the object with lower resistance, which may intensify the current crowding phenomenon.

For example, according to the electrode 140′ including a material with line resistance of 0.1 ohm/m or less and the graphene heating layer 130′ having surface resistance of 150 ohm/sq to 200 ohm/sq, there is a great resistance difference between the electrode 140′ and the graphene heating layer 130′ that are in contact with each other.

That is, in a structure such as the heating device 10′ according to the comparative embodiment in which the electrode 140′ and the graphene heating layer 130′ are in direct contact with each other, there may be a great resistance difference between the electrode 140′ and the graphene heating layer 130′, and therefore, a phenomenon in which current is concentrated to the electrode 140′ with relatively lower resistance may occur.

While current is concentrated to one of objects that are in contact with each other, the corresponding object may generate excessive heat compared to another object. That is, in the heating device 10′ according to the comparative embodiment, excessive heat may be generated in the electrode 140′ with relatively low resistance, which may become a cause of damaging the electrode 140′. Also, due to such excessive heating in the electrode 140′, thermal unbalance may occur at a contact surface (interface) between the electrode 140′ and the graphene heating layer 130′, and thus, a contact force between the electrode 140′ and the graphene heating layer 130′ may be weakened, which may cause a decrease in overall durability of the heating device 10′.

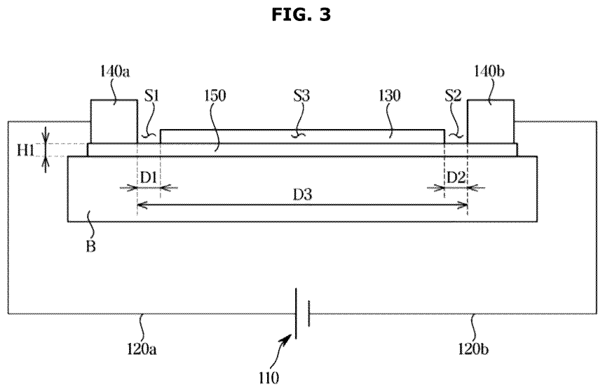

FIG. 2 conceptually shows a heating device according to an embodiment of the disclosure. FIG. 3 is a front view of FIG. 2. Hereinafter, descriptions about content overlapping with that described above will be omitted.

Referring to FIGS. 2 and 3, a heating device 10 may generate heat by receiving power.

The heating device 10 may be mounted on a base B. The base B may be a heating target that is heated by the heating device 10. The heating device 10 may heat the base B. Even though the base B is a heating target of the heating device 10, the heating device 10 may not be configured only for the purpose of heating the base B, and the heating device 10 may also be configured for the purpose of heating other components, devices, spaces, etc. other than the base B. The expression “the base B is a heating target that is heated by the heating device 10” may comprehensively refer to various examples in which the base B is heated while the heating device 10 generates heat by receiving power. The base B may include various kinds of components, devices, etc. capable of being heated by the heating device 10 mounted thereon.

The heating device 10 may include a power supply 110 that supplies power, an electrode 140 that receives a voltage from the power supply 110, a connector 120 that electrically connects the power supply 110 to the electrode 140, a graphene heating layer 130 that generates heat by receiving power, and a conductive layer 150 that enables current to flow from the electrode 140 to the graphene heating layer 130, the conductive layer 150 being laminated on the base B on which the heating device 10 is mounted.

For example, the heating device 10 may allow light to pass through. The heating device 10 may be light-transmissive. The heating device 10 may include a light-transmissive material. The heating device 10 may be transparent.

For example, the graphene heating layer 130 may allow light to pass through. For example, the conductive layer 150 may allow light to pass through. Light may pass through the graphene heating layer 130 and the conductive layer 150 in the order of the graphene heating layer 130 and the conductive layer 150 or in the order of the conductive layer 150 and the graphene heating layer 130. Therefore, one side of the heating device 10 may be easily recognized from another side.

For example, the base B may allow light to pass through. Because each of the graphene heating layer 130, the conductive layer 150, and the base B allows light to pass through, light may pass through the graphene heating layer 130, the conductive layer 150, and the base B in the order of the graphene heating layer 130, the conductive layer 150, and the base B or in the order of the base B, the conductive layer 150, and the graphene heating layer 130.

The power supply 110 may include various devices that receive power from a power generator or an external power source and transfer the power to a place requiring power.

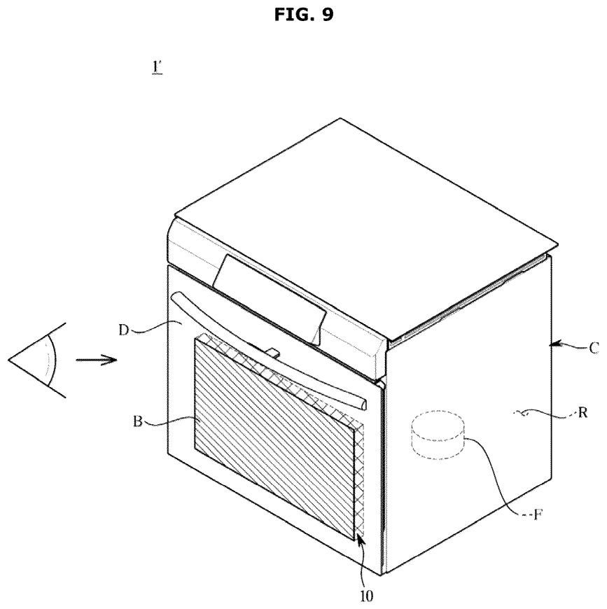

For example, the power supply 110 may be a battery storing power, a power source of various appliances such as a cooking appliance 1 which will be described below with reference to FIG. 9. The power supply 110 may include a battery. The power supply 110 may be a device that itself generates power and stores the power.

The power supply 110 is shown as a battery, however, this is only an example for description. The power supply 110 may be various devices that generate power or store and transfer power received from outside, as described above.

The electrode 140 may be connected to the power supply 110 by the connector 120. The electrode 140 may be electrically connected to the power supply 110. For example, the electrode 140 may be connected to the power supply 110 to receive a voltage from the power supply 110.

The electrode 140 may include a pair of electrodes 140a and 140b spaced a preset distance D3 from each other. The pair of electrodes 140a and 140b may be connected to the power supply 110 and function as a positive (+) pole 140a and a negative (−) pole 140b, respectively. A space S may be formed between the pair of electrodes 140a and 140b.

For example, the pair of electrodes 140a and 140b may include a first electrode 140a forming a positive pole and a second electrode 140b forming a negative pole.

For example, the first electrode 140a may be connected to the power supply 110 through a first connector 120a of the connector 120. For example, the second electrode 140b may be connected to the power supply 110 through a second connector 120b of the connector 120.

The pair of electrodes 140a and 140b may be spaced from each other on the conductive layer 150 laminated on the base B. In other words, the pair of electrodes 140a and 140b may be respectively seated on the conductive layer 150. For example, the pair of electrodes 140a and 140b may be in contact with the conductive layer 150.

The conductive layer 150 may be a planar conductor through which current flows, which will be described below. Accordingly, current generated by the electrode 140 that receives a voltage from the power supply 110 may flow on the conductive layer 150 that enables the pair of electrodes 140a and 140b to carry current to each other. For example, current may flow on an area of the conductive layer 150 positioned between the pair of electrodes 140a and 140b. For example, the pair of electrodes 140a and 140b may respectively be positioned at both ends of the conductive layer 150. However, positions of the pair of electrodes 140a and 140b are not limited thereto.

The electrode 140 may include a material which receives a voltage and through which current flows. For example, the electrode 140 may include, but is not limited thereto, a material of Ag or Cu. The electrode 140 may be formed by applying an electrode (140) paste containing Ag or Cu on the conductive layer 150, although not limited thereto.

The graphene heating layer 130 may include a graphene layer having a graphene material. The graphene layer may be a polymer carbon allotrope where carbon atoms are connected to each other in a hexagonal honeycomb shape to form a two-dimensional planar structure.

The corresponding shape may be referred to as a honeycomb structure or a honeycomb lattice.

For example, a crystal structure of the graphene material may mean a form in which hexagonal connections extend in a plane direction due to an atomic structure (sp2 bond) with three bonds attached to one vertex. As a result, the crystal structure of the graphene material may have a two-dimensional crystal shape that spreads widely in the plane direction, which may form hexagonal pores. Therefore, the graphene material may exist as a thin film with a thickness of one atom, and due to such a small thickness, the graphene material may have very low visible light absorption, thereby showing light-transmissive properties. As a result, the graphene heating layer 130 including the graphene material may be transparent.

For example, the graphene layer may be formed as a planar structure of single graphene. However, the graphene layer may include a structure where a plurality of graphene materials are laminated.

For example, graphene may have very high electron mobility and high thermal conductivity of about 5000 W/mK. In addition, graphene may have excellent electrical conductivity, have high strength due to the structural characteristics of the honeycomb-shaped two-dimensional plane, and also have excellent elasticity not to lose electrical properties even while being stretched or bent. Graphene without any defects may have heat resistance that withstands even at temperatures of 1000 degrees or more. Also, while current flows through graphene by connecting a positive pole and a negative pole to both ends of the graphene, the graphene may emit heat, as described above.

For example, the graphene heating layer 130 may be laminated on the conductive layer 150. For example, the graphene heating layer 130 may be in contact with the conductive layer 150. For example, the graphene heating layer 130 may be laminated on the conductive layer 150 by being transferring to the conductive layer 150. For example, the graphene heating layer 130 may be formed by transferring a graphene structure directly onto one side of the conductive layer 150. The conductive layer 150 may function as a substrate for supporting the graphene heating layer 130.

The graphene heating layer 130 may be spaced from the pair of electrodes 140a and 140b. In other words, the graphene heating layer 130 may be spaced from the pair of electrodes 140a and 140b in the space formed by spacing the pair of electrodes 140a and 140b from each other. That is, the conductive layer 150 may be connected to the graphene heating layer 130 and the electrodes 140. An arrangement in which the graphene heating layer 130 is spaced from the pair of electrodes 140a and 140b will be described in detail, below.

While a voltage is applied to the electrode 140 by the power supply 110, as described above, current may flow through the conductive layer 150 that allows the pair of electrodes 140a and 140b to carry current to each other. Because the graphene heating layer 130 is in contact with the conductive layer 150, current may be supplied to the graphene heating layer 130 through the conductive layer 150. Therefore, the graphene heating layer 130 that has received current may emit heat toward the base B.

For example, the base B may include, but is not limited thereto, a ceramic glass material. However, the base B may include various materials having light transmittance and high heat resistance.

According to the heating device 10 being mounted on the base B, the conductive layer 150 may be laminated on the base B. That is, the conductive layer 150 may be in direct contact with the base B. For example, a surface of the base B may include a curved shape, and the conductive layer 150 may also be deformed to be flexible to correspond to the curved shape. The conductive layer 150 may include a planar conductor. The conductive layer 150 may be formed as a single layer, although not limited thereto.

For example, according to the conductive layer 150 being a single layer, the conductive layer 150 may be formed to have a thickness H1 of 10 nm or less. According to the conductive layer 150 having the thickness H1 of 10 nm or less, a part of visible light traveling to the conductive layer 150 may not be absorbed in the conductive layer 150 due to the small thickness H1 of the conductive layer 150, and the visible light not absorbed may pass through the conductive layer 150. That is, the conductive layer 150 may be transparent due to the small thickness.

Therefore, according to the conductive layer 150 being laminated on the base B having light-transmissive properties, a part of visible light passed through the base B may also pass through the conductive layer 150 such that a user may observe an area beyond the base B and the conductive layer 150.

For example, the conductive layer 150 may include a material of Pt or Au. Accordingly, current may flow on the conductive layer 150. In addition, the conductive layer 150 may include various materials having high electrical conductivity.

However, the above-described content that the conductive layer 150 is formed as a single layer is only an example, and the conductive layer 150 may include a plurality of layers. Details about this will be described below.

Hereinafter, the structure where the electrode 140 is spaced from the graphene heating layer 130 will be described in detail.

According to various embodiments, there may be a great difference in resistance between the electrode 140 and the graphene heating layer 130.

For example, the electrode 140 may include a material of Ag-based paste, and contain Glass-frit to obtain high adhesion to the base B described above. For example, resistivity of the electrode 140 may be about 1.590×10⁻⁸ Ωcm. For example, the electrode 140 may have line resistance of about 0.1 ohm/m or less.

For example, resistivity of the graphene heating layer 130 may be about 3.5×10⁻⁶ Ωcm. For example, the graphene heating layer 130 may have surface resistance of about 150 ohm/sq to about 200 ohm/sq.

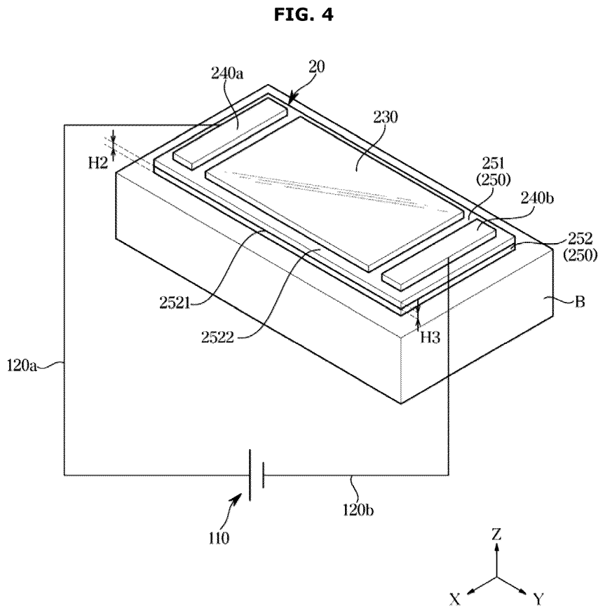

As such, according to an embodiment, the resistivity (e.g., 3.5×10⁻⁶ Ωcm) of the graphene heating layer 130 may be greater than the resistivity (e.g., 1.590×10⁻⁸ Ωcm) of the electrode 140, and in the case in which the electrode 140 is in contact with the graphene heating layer 130, this resistivity difference may induce a current crowding phenomenon. The current crowding phenomenon may reduce durability of the heating device 10. According to an embodiment of the disclosure, by spacing the electrode 140 from the graphene heating layer 130, such a current crowding phenomenon may be prevented (see FIG. 4).

According to an embodiment of the disclosure, even though the electrode 140 is spaced from the graphene heating layer 130, the electrode 140 and the graphene heating layer 130 may be electrically connected to each other by being connected to the conductive layer 150 having higher resistance than the electrode 140 and lower resistance than the graphene heating layer 130. According to an embodiment of the disclosure, resistance of the electrode 140, the conductive layer 150, and the graphene heating layer 130 may increase in the order of the electrode 140, the conductive layer 150, and the graphene heating layer 130.

For example, resistivity of the conductive layer 150 may be about 10.6×10⁻⁸ Ωcm. For example, surface resistance of the conductive layer 150 may be from about 150 ohm/sq to about 200 ohm/sq.

As such, according to an embodiment, in the case in which the electrode 140 is directly connected to the graphene heating layer 130, a difference in resistivity between the electrode 140 and the graphene heating layer 130 may be about 3.484×10⁻⁶ Ωcm. However, in the case in which the electrode 140 is indirectly connected to the graphene heating layer 130 through the conductive layer 150, a difference in resistivity between the electrode 140 and the conductive layer 150 may be about 9.01×10⁻⁸ Ωcm, and a difference in resistivity between the graphene heating layer 130 and the conductive layer 150 may be about 3.394×10⁻⁶ Ωcm. Therefore, it is confirmed that the difference in resistivity between the electrode 140 and the conductive layer 150 and the difference in resistivity between the graphene heating layer 130 and the conductive layer 150 are smaller than the difference in resistivity between the electrode 140 and the graphene heating layer 130. That is, compared to the embodiment in which the electrode 140 is directly connected to the graphene heating layer 130, in the embodiment in which the electrode 140 is indirectly connected to the graphene heating layer 130 through the conductive layer 150, a change in resistance at a contact surface between components may be more mitigated. Therefore, the current crowding phenomenon may be prevented, and the durability of the heating device 10 may be improved.

So far, a case in which the resistivity of the electrode 140 is about 1.590×10⁻⁸ Ωcm and the line resistance of the electrode 140 is about 0.1 ohm/m or less, a case in which the resistivity of the graphene heating layer 130 is about 3.5×10⁻⁶ Ωcm and the surface resistance of the graphene heating layer 130 is from about 150 ohm/sq to about 200 ohm/sq, and a case in which the resistivity of the conductive layer 150 is about 10.6×10⁻⁸ Ωcm and the surface resistance of the conductive layer 150 is from about 35 ohm/sq to about 40 ohm/sq have been described as examples. However, these are only examples, and in various embodiments, with regard to resistance of the electrode 140, the graphene heating layer 130, and the conductive layer 150, resistance of the electrode 140 may be smallest, resistance of the graphene heating layer 130 may be greatest, and resistance of the conductive layer 150 may vary within a range between the resistance of the electrode 140 and the resistance of the graphene heating layer 130.

As described above, by spacing the electrode 140 from the graphene heating layer 130 and achieving an electrical connection between the electrode 140 and the graphene heating layer 130 through the conductive layer 150, a path along which current flows may be designed in the order of electrode 140—conductive layer 150—graphene heating layer 130, and therefore, a difference in resistance may change in stages, thereby effectively preventing the current crowding phenomenon compared to a case in which resistance changes sharply.

For example, the first electrode 140a may be spaced a first distance D1 from the graphene heating layer 130. In other words, the first electrode 140a and the graphene heating layer 130 may be arranged to form a first space S1 therebetween. The first electrode 140a and the graphene heating layer 130 may be in contact with the conductive layer 150. Accordingly, the first electrode 140 and the graphene heating layer 130 may carry current to each other even though the first electrode 140 and the graphene heating layer 130 are not in direct contact with each other.

For example, the second electrode 140b may be spaced a second distance D2 from the graphene heating layer 130. In other words, the second electrode 140b and the graphene heating layer 130 may be arranged to form a second space S2 therebetween. The second electrode 140b and the graphene heating layer 130 may be in contact with the conductive layer 150. Accordingly, the second electrode 140b and the graphene heating layer 130 may carry current to each other even though the second electrode 140b and the graphene heating layer 130 are not in direct contact with each other.

For example, the second distance D2 may correspond to the first distance D1, although not limited thereto. Therefore, the first distance D1 and the second distance D2 may be set variously depending on a usage environment and characteristics.

The graphene heating layer 130 may be positioned in a third space S3 between the first space S1 and the second space S2 and extend along the third space S3.

Even though the first electrode 140a, the graphene heating layer 130, and the second electrode 140b are spaced from each other without being in direct contact with each other, the first electrode 140a, the graphene heating layer 130, and the second electrode 140b may carry current to each other through the conductive layer 150. Accordingly, the first electrode 140a, the graphene heating layer 130, and the second electrode 140b may carry current to each other while preventing the current crowding phenomenon.

For example, the thickness H1 of the conductive layer 150 may be various. For example, the thickness H1 of the conductive layer 150 may be, but is not limited thereto, from 5 nm to 10 nm.

As the thickness H1 of the conductive layer 150 increases, resistance of the conductive layer 150 may be reduced, and as the thickness H1 of the conductive layer 150 is reduced, resistance of the conductive layer 150 may increase. The electrode 140 having various resistance according to kinds of the electrode 140 may be applied to the heating device 10, and resistance of the conductive layer 150 may be set to resistance between resistance of the electrode 140 and resistance of the graphene heating layer 130 by adjusting the thickness H1. Accordingly, the current crowding phenomenon described above may be effectively prevented.

In the comparative embodiment, while heat is generated in the graphene heating layer 130′, a force may be applied to a contact part between the electrode 140′ and the graphene heating layer 130′ due to a difference in thermal expansion coefficient between the electrode 140′ and the graphene heating layer 130′. For example, the electrode 140 and the graphene heating layer 130 may have different thermal expansion coefficients. While heat is applied, the electrode 140 may expand, but the graphene heating layer 130 may contract. For example, according to the electrode 140 containing a material of Ag-based paste, a thermal expansion coefficient of the electrode 140 may be 19.5*10⁻⁶ (K⁻¹) and a thermal expansion coefficient of the graphene heating layer 130 may be −8.0*10⁻⁶(K⁻¹), although not limited thereto.

In the comparative embodiment, because the electrode 140′ and the graphene heating layer 130′ are deformed to contract/expand in different directions, a horizontal shearing force may occur at the contact surface between the electrode 140′ and the graphene heating layer 130′, which may cause the electrode 140′ and the graphene heating layer 130′ to be separated from each other, resulting in a decrease in durability of the heating device 10′.

While a shearing force is generated at an interface between the graphene heating layer 130′ and the electrode 140′, as described above, migration of metal atoms may occur, which may further deteriorate the durability of the heating device 10′. In addition, a short circuit may occur at the interface between the electrode 140′ and the graphene heating layer 130′.

According to an embodiment in which the electrode 140 is spaced from the graphene heating layer 130, generation of a shearing force and generation of migration due to a difference in thermal expansion coefficients may be suppressed, and therefore, deterioration in durability of the heating device 10 may be prevented.

Referring to FIGS. 2 and 3, the conductive layer 150 may connect the pair of electrodes 140a and 140b to each other. The conductive layer 150 may be connected to both the first electrode 140a and the second electrode 140b. The conductive layer 150 may extend from the first electrode 140a to the second electrode 140b. A contact surface of the conductive layer 150 with the graphene heating layer 130 may extend from one side of the graphene heating layer 130 adjacent to one (e.g., the first electrode 140a) of the pair of electrodes 140a and 140b to another side of the graphene heating layer 130 adjacent to another one (e.g., the second electrode 140b) of the pair of electrodes 140a and 140b. In other words, the conductive layer 150 may be substantially in contact with an entire of one surface of the graphene heating layer 130.

As such, because the conductive layer 150 is substantially in contact with the entire of one surface of the graphene heating layer 130, uniformity of voltage application to the graphene heating layer 130 may increase, and a degree of heat generation over a substantially entire area of the graphene heating layer 130 may become more uniform. In addition, a current crowding phenomenon at a specific area of the graphene heating layer 130 may be further reduced and/or prevented.

FIG. 4 conceptually shows a heating device according to an embodiment of the disclosure. Hereinafter, descriptions about content overlapping with that described above will be omitted.

Referring to FIG. 4, a conductive layer 250 may include a first conductive film 252 that is in contact with the base B.

The conductive layer 250 may include a second conductive film 251 positioned between the first conductive film 252 and the graphene heating layer 230.

For example, the first conductive film 252 may include a material of Pt or Au. Accordingly, current may flow on the first conductive film 252. For example, the first conductive film 252 may have a thickness H2 of about 10 nm or less. For example, the first conductive film 252 may include a planar conductor.

The second conductive film 251 may include a first surface 2521 that is in contact with the first conductive film 252, and a second surface 2522 that is in contact with the graphene heating layer 230 and is an opposite surface of the first surface 2521. That is, the graphene heating layer 230 may be laminated on the conductive layer 250 in such a way as to be in contact with the second conductive film 251.

A pair of electrodes 240a and 240b may be positioned on the second conductive film 251. Each of the pair of electrodes 240a and 240b may be in contact with the second conductive film 251. The pair of electrodes 240a and 240b and the graphene heating layer 230 may be spaced from each other on the second conductive film 251.

For example, the second conductive film 251 may include a material through which current flows. For example, the second conductive film 251 may have a thickness H3 of 5 nm or less. For example, the second conductive film 251 may include a planar conductor.

Due to the above-described arrangement and the characteristics of the second conductive film 251, current may migrate between the pair of electrodes 240a and 240b and the graphene heating layer 230. The pair of electrodes 240a and 240b and the graphene heating layer 230 may carry current to each other by the second conductive film 251 and the first conductive film 252.

For example, the second conductive film 251 may include a material of titanium (Ti) or nickel (Ni). Because the second conductive film 251 including the above-mentioned material is positioned between the graphene heating layer 230 and the first conductive film 252, a shearing force that may be generated at a contact surface between the graphene heating layer 230 and the first conductive film 252 due to a difference in thermal conductivity between the graphene heating layer 230 and the first conductive film 252 may be further reduced.

Also, in a case in which the graphene heating layer 230 is in direct contact with the first conductive film 252, a surface energy difference due to a difference between materials may be made between the graphene heating layer 230 and the first conductive film 252, and accordingly, dewetting or differentiation may occur at the contact surface between the graphene heating layer 230 and the first conductive film 252.

According to occurrence of dewetting or differentiation, a contact force at the contact surface between the graphene heating layer 230 and the first conductive film 252 may become weak, and thus, the graphene heating layer 230 may be lifted. However, because the second conductive film 251 containing a material of Ti or Ni is positioned between the graphene heating layer 230 and the first conductive film 252, the phenomenon may be prevented.

Referring to FIG. 4, the conductive layer 250 may connect the pair of electrodes 240a and 240b to each other. The conductive layer 250 may be connected to both the first electrode 240a and the second electrode 240b. The conductive layer 250 may extend from the first electrode 240a to the second electrode 240b. A contact surface (e.g., the second surface 2522) of the conductive layer 250 with the graphene heating layer 230 may extend from one side of the graphene heating layer 230 adjacent to one (e.g., the first electrode 240a) of the pair of electrodes 240a and 240b to another side of the graphene heating layer 230 adjacent to another one (e.g., the second electrode 240b) of the pair of electrodes 240a and 240b. In other words, the conductive layer 250 may be substantially in contact with an entire of one surface of the graphene heating layer 230.

As such, because the conductive layer 250 is substantially in contact with the entire of one surface of the graphene heating layer 230, uniformity of voltage application to the graphene heating layer 230 may increase, and a degree of heat generation over a substantially entire area of the graphene heating layer 230 may become more uniform. Also, generation of a current crowding phenomenon at a specific area of the graphene heating layer 230 may be further reduced and/or prevented.

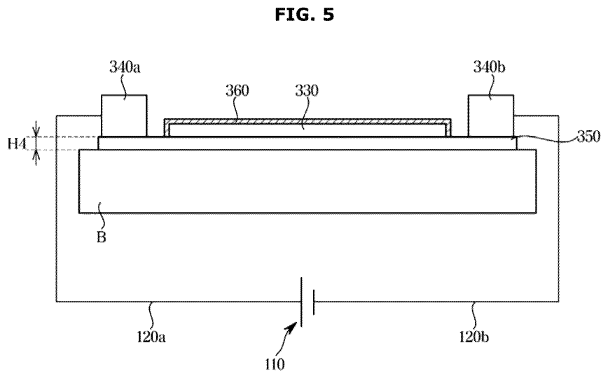

FIG. 5 conceptually shows a heating device according to an embodiment of the disclosure. Hereinafter, descriptions about content overlapping with that described above will be omitted.

Referring to FIG. 5, a heating device 20 may include an encapsulation layer 360 that covers a graphene heating layer 330. The encapsulation layer 360 may cover one surface of the graphene heating layer 330, which is different from another surface being in contact with a conductive layer 350. The encapsulation layer 360 may surround the graphene heating layer 330 to prevent the graphene heating layer 330 from being exposed to air.

The encapsulation layer 360 may include an oxide metal material. The encapsulation layer 360 may include various kinds of oxide metals of oxide series. Therefore, the encapsulation layer 360 may prevent the graphene heating layer 330 from being oxidized by being exposed to air. According to application of a voltage to the graphene heating layer 330, the graphene heating layer 330 may be heated to a high temperature and easily oxidized when being exposed to air. By surrounding the graphene heating layer 330 with the encapsulation layer 360 including an oxide metal material, the graphene heating layer 330 may be efficiently prevented from being oxidized. Accordingly, durability of the graphene heating layer 330 and overall durability of the heating device 20 may be improved.

The encapsulation layer 360 may be formed with a sufficiently small thickness to allow light to pass through.

Referring to FIG. 5, the conductive layer 350 may connect a pair of electrodes 340a and 340b to each other. The conductive layer 350 may be connected to both the first electrode 340a and the second electrode 340b. The conductive layer 350 may extend from the first electrode 340a to the second electrode 340b. A contact surface of the conductive layer 350 with the graphene heating layer 330 may extend from one side of the graphene heating layer 330 adjacent to one (e.g., the first electrode 340a) of the pair of electrodes 340a and 340b to another side of the graphene heating layer 330 adjacent to another one (e.g., the second electrode 340b) of the pair of electrodes 340a and 340b. In other words, the conductive layer 350 may be substantially in contact with an entire of one surface of the graphene heating layer 330.

As such, because the conductive layer 350 is substantially in contact with the entire of one surface of the graphene heating layer 330, uniformity of voltage application to the graphene heating layer 330 may increase, and a degree of heat generation over a substantially entire area of the graphene heating layer 330 may become more uniform. Also, generation of a current crowding phenomenon at a specific area of the graphene heating layer 330 may be further reduced and/or prevented.

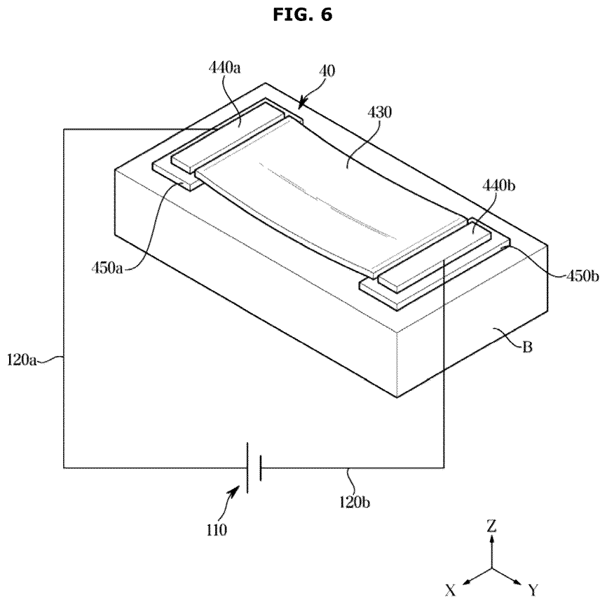

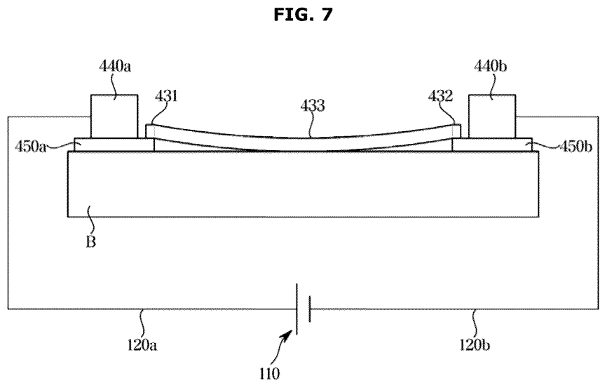

FIG. 6 conceptually shows a heating device according to an embodiment of the disclosure. FIG. 7 is a front view of FIG. 6. Hereinafter, descriptions about content overlapping with that described above will be omitted.

Referring to FIGS. 6 and 7, a conductive layer 450 may include a first conductive layer 450a on which a first electrode 440a is seated, and a second conducive layer 450b on which a second electrode 440b is seated and which is spaced from the first conductive layer 450a. For example, the first conductive layer 450a and the second conductive layer 450b may include, but is not limited thereto, a material of Pt or Au.

The graphene heating layer 430 may be positioned such that one side of the graphene heating layer 430 is in contact with the first conductive layer 450a. The one side of the graphene heating layer 430, which is in contact with the first conductive layer 450a, may be referred to as a first area 431. That is, the graphene heating layer 430 may include the first area 431.

For example, the first area 431 may be one end of the graphene heating layer 430 in a horizontal direction. For example, the first area 431 may be in contact with the first conductive layer 450a.

The first area 431 may be spaced from the first electrode 440a.

The graphene heating layer 430 may be positioned such that another side of the graphene heating layer 430a is in contact with the second conductive layer 450b. The other side of the graphene heating layer 430, which is in contact with the second conductive layer 450b, may be referred to as a second area 432. That is, the graphene heating layer 430 may include the second area 432.

For example, the second area 432 may be another end of the graphene heating layer 430 in the horizontal direction. For example, the second area 432 may be in contact with the second conductive layer 450b. The second area 432 may be spaced from the second electrode 440b.

Another part of the graphene heating layer 430 between the first area 431 and the second area 432 may be referred to as a third area 433.

The graphene heating layer 430 may be flexible, and accordingly, the third area 433 may move by gravity to be positioned lower than the first area 431 and the second area 432.

For example, the third area 433 may be in contact with the base B. For example, the third area 433 may be positioned in a space formed by the first conductive layer 450a and the second conductive layer 450b spaced from each other. The third area 433 may extend in the space formed by the first conductive layer 450a and the second conductive layer 450b spaced from each other and be in contact with the base B.

Current may flow through the conductive layer 450 and the graphene heating layer 430. Also, because the first electrode 440a carries current to the graphene heating layer 430 through the first conductive layer 450a and the second electrode 440b carries current to the graphene heating layer 430 through the second conductive layer 450b, current may flow on the first electrode 440a, the graphene heating layer 430, and the second electrode 440b.

Because the conductive layer 450 is formed as the first conductive layer 450a and the second conductive layer 450b spaced from each other without extending on the base B to correspond to a width of the heating device, manufacturing cost of the conductive layer 450 may be reduced.

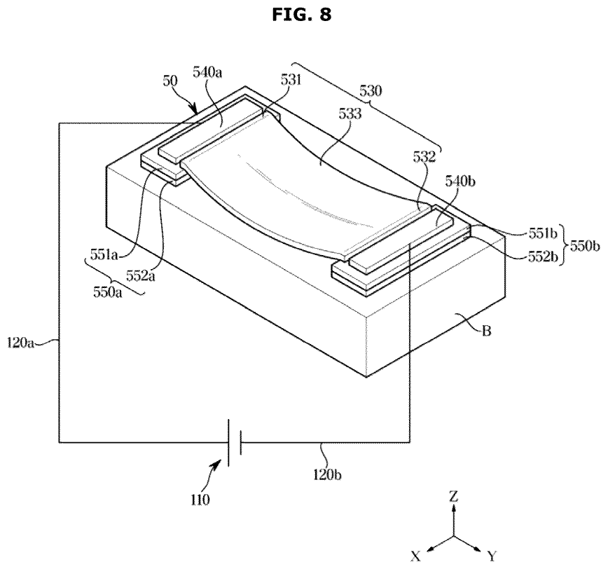

FIG. 8 conceptually shows a heating device according to an embodiment of the disclosure. Hereinafter, descriptions about content overlapping with that described above will be omitted.

Referring to FIG. 8, a first conductive layer 550a may include a first conductive film 552a that is in contact with the base B, and a second conductive film 551a positioned between the first conductive film 552a and a graphene heating layer 530.

Also, a second conductive layer 550b may include a third conductive film 552b that is in contact with the base B, and a fourth conductive film 551b positioned between the third conductive film 552b and the graphene heating layer 530.

Each of the first conductive film 552a and the third conductive film 552b may include, but is not limited thereto, a material of Pt or Au. Each of the second conductive film 551a and the fourth conductive film 551b may include, but is not limited thereto, a material of Ti or Ni.

The graphene heating layer 530 may be positioned such that one side of the graphene heating layer 530 is in contact with the second conductive film 551a. The one side of the graphene heating layer 530, which is in contact with the second conductive film 551a, may be referred to as a first area 531. That is, the graphene heating layer 530 may include the first area 531.

For example, the first area 531 may be one end of the graphene heating layer 530 in the horizontal direction. For example, the first area 531 may be in contact with the first conductive layer 550a. The first area 531 may be spaced from the first electrode 540a.

The graphene heating layer 530 may be positioned such that another side of the graphene heating layer 530 is in contact with the fourth conductive film 551b. The other end of the graphene heating layer 530, which is in contact with the fourth conductive film 551b, may be referred to as a second area 532. That is, the graphene heating layer 530 may include the second area 532. For example, the second area 532 may be another end of the graphene heating layer 530 in the horizontal direction. For example, the second area 532 may be another end of the graphene heating layer 530 in the horizontal direction. For example, the second area 532 may be in contact with the fourth conductive film 551b. The second area 532 may be spaced from the second electrode 540b.

Another part of the graphene heating layer 530 between the first area 531 and the second area 532 may be referred to as a third area 533. The graphene heating layer 530 may be flexible, and accordingly, the third area 533 may move by gravity to be positioned lower than the first area 531 and the second area 532. For example, the third area 533 may be in contact with the base B.

For example, the third area 533 may be positioned in a space formed by the first conductive layer 550a and the second conductive layer 550b spaced from each other.

FIG. 9 conceptually shows a cooking appliance in which a heating device according to various embodiments of the disclosure is installed.

Referring to FIG. 9, the heating device 10 according to various embodiments of the disclosure may be installed in the cooking appliance 1. The cooking appliance 1 may include the heating device 10. Hereinafter, a case in which the heating device 10 included in the cooking appliance 1 is the heating device 10 of FIGS. 2 and 3 will be described as an example. However, the cooking appliance 1 may include the heating devices 10, 20, 30, 40, and 50 according to embodiments described with reference to FIGS. 2 to 8.

According to various embodiments, the cooking appliance 1 may include a main body C that forms an appearance and a cooking room R in which food contained in a cooking container F is cooked. The cooking appliance 1 may include a door D rotatably coupled to the main body C to open or close the cooking room R. The door D may include a window B through which light is transmitted to show inside of the cooking room R from outside.

For example, the window B may include a glass material through which light is transmitted. For example, the window B may include a ceramic glass material. However, a material of the window B is not limited thereto. In various embodiments, the window B may include various materials which are light-transmissive and have high heat resistance.

The heating device 10 may be installed inside the cooking appliance 1. The heating device 10 may be installed inside the cooking appliance 1 to heat the cooking room R. For example, the heating device 10 may be installed on the door D. The heating device 10 may be installed on one surface of the door D toward the inside of the cooking room R. The heating device 10 may be installed on one surface of the window B toward the inside of the cooking room R.

However, a location of the heating device 10 is not limited thereto, and the heating device 10 may be installed at any location of the cooking appliance 1 as long as the heating device 10 is capable of heating the cooking room R. For example, the heating device 10 may be positioned at an upper side of the cooking room R across the cooking room R or at a rear inner surface of the main body C while facing the door D, as long as the heating device 10 is capable of heating the cooking room R.

Hereinafter, a case in which the heating device 10 is installed on an inner surface of the window B toward the cooking room R will be assumed and described. That is, the window B may be a base B which is a heating target to be heated and on which the heating device 10 is installed.

As described above, each of the window B and the heating device 10 may allow light to pass through. Each of the window B, the conductive layer 150, and the graphene heating layer 130 may allow light to pass through.

Accordingly, the window B, the graphene heating layer 130, and the conductive layer 150 may allow outside light of the cooking appliance 1 to pass through and enter the cooking room R, or may allow internal light of the cooking room R to pass through and be emitted to outside of the cooking appliance 1. For example, outside light of the cooking appliance 1 may pass through the window B, the conductive layer 150, and the graphene heating layer 130 in this order, and enter the cooking room R. Internal light of the cooking room R may pass through the graphene heating layer 130, the conductive layer 150, and the window B in this order and be emitted to the outside of the cooking appliance 1.

Therefore, because visibility of the cooking room R is secured, a user located outside the cooking appliance 1 may observe the inside of the cooking room R through the window B and the heating device 10 and easily check a cooking state of food in the cooking container F inside the cooking room R.

In various embodiments, the heating device 10 may be installed in and applied to various components, devices, etc., which need to be heated, in addition to the cooking appliance 1.

The heating device 10 according to an embodiment of the disclosure may include the power supply 110, the graphene heating layer 130 configured to generate heat by receiving power and allow light to pass through, the electrode 140 connected to the power supply 110 to receive a voltage from the power supply 110 and spaced from the graphene heating layer 130, and the conductive layer 150 laminated on the base B which is to be heated, configured to allow current to flow through, and connected to the graphene heating layer 130 and the electrode 140 to allow the graphene heating layer 130 and the electrode 140 to carry current to each other.

The electrode 140 may include the pair of electrodes 140a and 140b spaced from each other and seated on the conductive layer 150. The graphene heating layer 130 may be positioned in a space formed by the pair of electrodes 140a and 140b spaced from each other, the graphene heating layer 130 being spaced from the pair of electrodes 140a and 140b.

The pair of electrodes 140a and 140b and the graphene heating layer 130 may be in contact with the conductive layer 150. The conductive layer 150 may allow light to pass through.

Resistance of the conductive layer 150 may be greater than resistance of the electrode 140 and smaller than resistance of the graphene heating layer 130.

The pair of electrodes 140a and 140b and the graphene heating layer 130 may be seated on one surface of the conductive layer 150. An area of the one surface of the conductive layer 150 may be wider than a sum of areas of contact surfaces of the pair of electrodes 140a and 140b with the one surface and an area of a contact surface of the graphene heating layer 130 with the one surface.

A contact surface of the conductive layer 150 with the graphene heating layer 130 may extend from one side of the graphene heating layer 130 adjacent to an electrode of the pair of electrodes 140a and 140b to another side of the graphene heating layer 130 adjacent to another electrode of the pair of electrodes 140a and 140b.

The conductive layer 250 may include the first conductive film 252 being in contact with the base B.

A thickness of the first conductive film 252 may be 10 nm or less.

The conductive layer 250 may further include the second conductive film 251 positioned between the first conductive film 252 and the graphene heating layer 230, wherein the first surface 2521 of the second conductive film 251 is in contact with the first conductive film 252, and the second surface 2522 of the second conductive film 251 is in contact with the graphene heating layer 230, the second surface 2522 being opposite to the first surface 2521.

The second conductive film 251 may include a material of Ti or Ni.

A thickness of the second conductive film 241 may be 5 nm or less.

The heating device 20 may further include the encapsulation layer 360 covering a surface of the graphene heating layer 330, which is different from another surface of the graphene heating layer 330 being in contact with a conductive layer 350. The encapsulation layer 360 may include an oxide metal material.

The pair of electrodes 440a and 440b may include the first electrode 440a and the second electrode 440b spaced from the first electrode 440a. The conductive layer 450 may include the first conductive layer 450a on which the first electrode 440a is seated, and the second conductive layer 450b on which the second electrode 440b is seated, the second conductive layer 450b being spaced from the first conductive layer 450a.

The graphene heating layer 430 may include the first area 431 being in contact with the first conductive layer 450a and spaced from the first electrode 440a, the second area 432 being in contact with the second conductive layer 450b and spaced from the second electrode 440b, and the third area 433 positioned between the first area 431 and the second area 432 and being in contact with the base B.

The first conductive layer 550a may include the first conductive film 552a being in contact with the base B, and the second conductive film 551a positioned between the first conductive film 552a and the graphene heating layer 530. The second conductive layer 550b may include the third conductive film 552b being in contact with the base B, and the fourth conductive film 551b positioned between the third conductive film 552b and the graphene heating layer 530.

The graphene heating layer 130 may be transferred to the conductive layer 150 and laminated on the conductive layer 150, and the heating device 10 may be light-transmissive.

The cooking appliance 1 according to an embodiment of the disclosure may include the main body C having the cooking room R, the door D rotatably coupled to the main body C and configured to open or close the cooking room R, and the heating device 10 installed on the door D and configured to heat the cooking room R. The heating device 10 may include the power supply 110, the pair of electrodes 140a and 140b connected to the power supply 110 to receive a voltage from the power supply 110 and spaced from each other, the graphene heating layer 130 configured to generate heat by receiving power and allow light to pass through, the graphene heating layer 130 being spaced from the pair of electrodes 140a and 140b, and the conductive layer 150 configured to allow current to flow through and allow the pair of electrodes 140a and 140b and the graphene heating layer 130 to carry current to each other, wherein the pair of electrodes 140a and 140b and the graphene heating layer 130 are seated on one surface of the conductive layer 150, and another surface of the conductive layer 150 is in contact with the base B on which the heating device 10 is mounted, the other surface of the conductive layer 150 being opposite to the one surface of the conductive layer 150.

The graphene heating layer 130 may be positioned in a space S1 and S2 formed by spacing the pair of electrodes 140a and 140b from each other, and may be spaced from the pair of electrodes 140a and 140b.

The pair of electrodes 140a and 140b and the graphene heating layer 130 may be respectively seated on one surface of the conductive layer 150. An area of one surface of the conductive layer 150 may be wider than a sum of areas of contact surfaces of the pair of electrodes 140a and 140b with the one surface and an area of a contact surface of the graphene heating layer 130 with the another surface.

The pair of electrodes 140a and 140b and the graphene heating layer 130 may be in contact with the conductive layer 250.

The pair of electrodes 440a and 440b may include the first electrode 440a and the second electrode 440b spaced from the first electrode 440a. The conductive layer 450 may include the first conductive layer 450a on which the first electrode 440a is seated, and the second conductive layer 450b which is spaced from the first conductive layer 450a and on which the second electrode 440b is seated.

The door D may include the window B that allows light to pass through. The conductive layer 150 may allow light to pass through. The window B, the graphene heating layer 130, and the conductive layer 150 may be configured to allow outside light of the cooking appliance 1 to pass through and enter the cooking room R or allow internal light of the cooking room R to pass through and be emitted to the outside of the cooking appliance 1.

According to a concept of the disclosure, because the conductive layer and the graphene heating layer maintain light transmittance, the heating device that secures a user's visibility may be provided.

According to a concept of the disclosure, because the electrodes and the graphene heating layer are spaced from each other and are in contact with the conductive layer, current may move from the electrodes to the graphene heating layer via the conductive layer. Therefore, a current crowding phenomenon caused by a great resistance difference may be prevented, and durability may be improved.

According to a concept of the disclosure, because the electrodes and the graphene heating layer are not in direct contact with each other, a short circuit of the heating device caused by a difference in thermal expansion coefficient between the electrodes and the graphene heating layer at a high temperature may be prevented.

According to a concept of the disclosure, because the conductive layer includes the second conductive film containing a material of Ti and being in contact with the graphene heating layer, stress that is applied to the graphene heating layer may be reduced compared to a case in which the graphene heating layer is in contact with the first conductive film.

Effects that may be achieved by the disclosure are not limited to the above-mentioned effects, and other effects not mentioned will be clearly understood by one of ordinary skill in the technical field to which the disclosure belongs from the following descriptions.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A heating device comprising:
a power supply;
a graphene heating layer configured to generate heat based on a current from the power supply and to allow light to pass therethrough;
an electrode connected to the power supply and spaced apart from the graphene heating layer, the electrode being configured to receive the current from the power supply; and
a conductive layer on a base and electrically connecting the graphene heating layer and the electrode.

2. The heating device of claim 1, wherein the electrode comprises a first electrode and a second electrode that are spaced apart on the conductive layer, and
wherein the graphene heating layer is between the first electrode and the second electrode, and spaced apart from the first electrode and the second electrode.

3. The heating device of claim 2, wherein the first electrode, the second electrode, and the graphene heating layer are in contact with the conductive layer, and wherein the conductive layer is configured to allow light to pass between the base and the graphene heating layer.

4. The heating device of claim 1, wherein a resistance of the conductive layer is greater than a resistance of the electrode and less than a resistance of the graphene heating layer.

5. The heating device of claim 2, wherein the first electrode, the second electrode, and the graphene heating layer are on a first surface of the conductive layer, and
wherein an area of the first surface of the conductive layer is greater than a sum of an area of a contact surface of the first electrode with the first surface, an area of a contact surface of the second electrode with the first surface, and an area of a contact surface of the graphene heating layer with the first surface.

6. The heating device of claim 2, wherein a contact surface of the conductive layer with the graphene heating layer extends from a first side of the graphene heating layer that is adjacent to the first electrode to a second side of the graphene heating layer that is adjacent to the second electrode.

7. The heating device of claim 1, wherein the conductive layer comprises a first conductive film in contact with the base.

8. The heating device of claim 7, wherein the conductive layer further comprises a second conductive film between the first conductive film and the graphene heating layer, and
wherein a first surface of the second conductive film is in contact with the first conductive film, and a second surface of the second conductive film is in contact with the graphene heating layer, the second surface being opposite to the first surface.

9. The heating device of claim 8, wherein the second conductive film comprises titanium or nickel.

10. The heating device of claim 8, wherein a thickness of the second conductive film is 5 nm or less.

11. The heating device of claim 1, wherein a first surface of the graphene heating layer is in contact with the conductive layer,
wherein the heating device further comprises:
an encapsulation layer covering a second surface of the graphene heating layer that is opposite to the first surface, and
wherein the encapsulation layer comprises an oxide metal material.

12. The heating device of claim 2, wherein the conductive layer comprises a first conductive layer on which the first electrode is provided, and a second conductive layer on which the second electrode is provided, the second conductive layer being spaced apart from the first conductive layer.

13. The heating device of claim 12, wherein the graphene heating layer comprises:
a first area in contact with the first conductive layer and spaced apart from the first electrode,
a second area in contact with the second conductive layer and spaced apart from the second electrode, and
a third area between the first area and the second area and in contact with the base.

14. The heating device of claim 12, wherein the first conductive layer comprises a first conductive film in contact with the base, and a second conductive film between the first conductive film and the graphene heating layer, and
wherein the second conductive layer comprises a third conductive film in contact with the base, and a fourth conductive film between the third conductive film and the graphene heating layer.

15. The heating device of claim 1, wherein the graphene heating layer is laminated on the conductive layer, and
wherein the heating device is configured to be light-transmissive.

16. The heating device of claim 1, wherein the graphene heating layer is indirectly connected to the electrode through the conductive layer.

17. A heating device comprising:
a power supply;
an electrode connected to the power supply, configured to receive current from the power supply, the electrode comprising a first electrode and a second electrode spaced apart from the first electrode;
a conductive layer electrically connected to the first electrode and the second electrode, the conductive layer comprising a first side in contact with a base;
a graphene heating layer in contact with the conductive layer and between the first electrode and the second electrode, the graphene heating layer being configured to generate heat based on the current from the power supply and to allow light to pass therethrough,
wherein the first electrode, the second electrode, and the graphene heating layer are on a second side of the conductive layer that is opposite to the first side.

18. The heating device of claim 17, wherein the conductive layer is configured to allow light to pass between the base and the graphene heating layer.

19. The heating device of claim 18, wherein the conductive layer comprises a first conductive film comprising the first side in contact with the base, and a second conductive film in contact with the first conductive film and comprising the second side that is opposite to the first side.

20. The heating device of claim 19, wherein a resistance of the conductive layer is greater than a resistance of the electrode and less than a resistance of the graphene heating layer.
